(19) United States
(12) Patent Application Publication
(10) Pub. No.: US 2013/0219085 A1
(43) Pub. Date: Aug. 22, 2013

(54) MULTI-DISK COMBINATION DEVICE AND METHOD FOR COMBINING A PLURALITY OF USB FLASH DRIVES

(71) Applicant: HON HAI PRECISION INDUSTRY CO., LTD., (US)

(72) Inventor: SZU-LUN HUANG, Tu-Cheng (TW)

(73) Assignee: HON HAI PRECISION INDUSTRY CO., LTD., Tu-Cheng (TW)

(21) Appl. No.: 13/625,900

(22) Filed: Sep. 25, 2012

(30) Foreign Application Priority Data
Feb. 22, 2012 (TW) 101105916

(51) Int. Cl. G06F 3/00

(52) U.S. Cl. 710/13

(57) ABSTRACT

In a method for combining universal serial bus (USB) flash drives using a multi-disk combination device, the multi-disk combination device includes a USB input port and several USB output ports. The method sets an initialization voltage value of each of the USB output ports as a low voltage level, and detects a current voltage value of each of the USB output ports while the USB input port is plugged into a USB connection of an electronic device. The method determines whether any USB output port connects to a USB flash drive, builds a disk array mode for all USB flash drives connected to the USB output ports, and controls each of the USB flash drives to store data of the electronic device in the disk array mode through a USB output port corresponding to the USB flash drive.

### BACKGROUND

1. Technical Field

Embodiments of the present disclosure relate to image processing systems and methods, and particularly to a multi-disk combination device and a method for combining a plurality of universal serial bus (USB) flash drives.

2. Description of Related Art

USB flash drives (hereinafter referred to U-drives) are widely used to store data from an electronic device, such as a computer, a mobile phone, or a video player. When massive amounts of data need to be stored into the U-drives, one U-drive cannot store such massive data since the storage capacity of the U-drive is limited. At present, there is no device and method for combining a plurality of U-drives to build a disk array for storing massive amounts of data. Therefore, there is a need to provide a multi-disk combination device and a method to overcome these above mentioned limitations.

### BRIEF DESCRIPTION OF THE DRAWINGS

FIG. 1 is a block diagram of one embodiment of a multi-disk combination device.

FIG. 2 is a flowchart of one embodiment of a method for combining a plurality of USB flash drives using the device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage system. Some non-limiting examples of a non-transitory computer-readable medium include CDs, DVDs, flash memory, and hard disk drives.

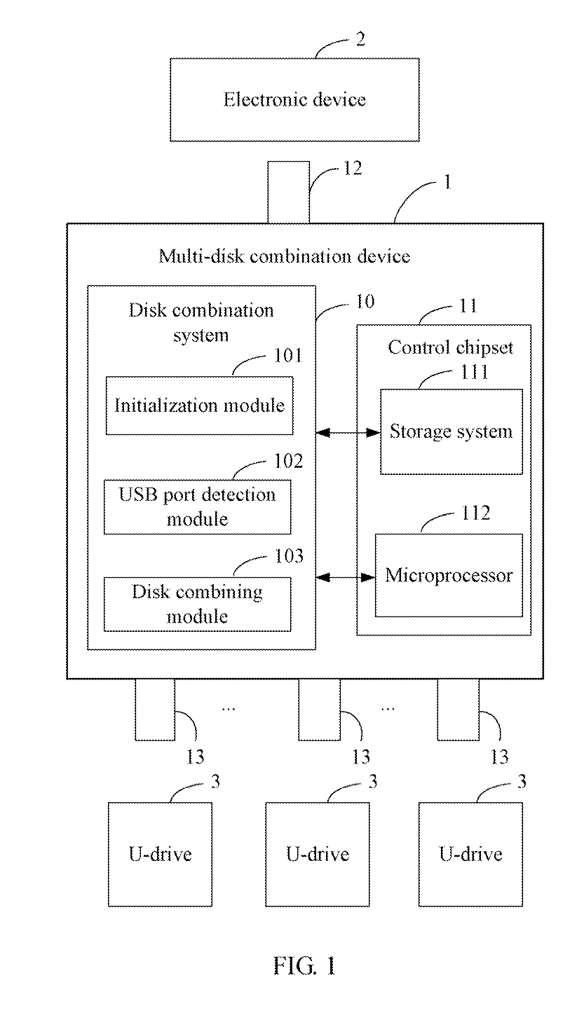

FIG. 1 is a block diagram of one embodiment of a multi-disk combination device 1. In the embodiment, the multi-disk combination device 1 includes a disk combination system 10, a control chipset 11, a universal serial bus (USB) input port 12, and a plurality of USB output ports 13. The control chipset 11 includes a storage system 111 and at least one microprocessor 112. The disk combination system 10 may include a plurality of functional modules that are stored in the storage system 111 and executed by the at least one microprocessor 112. FIG. 1 is only one example of the multi-disk combination device 1, other examples may include more or fewer components than those shown in the embodiment, or have a different configuration of the various components.

The USB input port 12 is electronically connected to a USB connection of an electronic device 2, and each of the USB output ports 13 is electronically connected to a USB flash drive (hereinafter “U-drive”) 3. In one embodiment, the electronic device 2 is a computer, a mobile phone, an electronic photo book, a notebook, or a personal digital assistant (PDA) device or a video player. In other embodiment, the U-drive 3 can be a mini hard disk, or any other memory device.

The multi-disk combination device 1 connects to the electronic device 2 through the USB input port 12, and connects to one or more U-drives 3 through the plurality of USB output ports 13. Each of the USB output ports 13 and the attached U-drive form a data transmission channel between the electronic device 2 and the U-drive 3. The multi-disk combination device 1 further combines the one or more U-drives 3 to create a disk array when the USB input port 12 is plugged into a USB connection port of the electronic device 2, to provide more storage capacity to store massive data from the electronic device 2.

In one embodiment, the storage system 111 may be an internal storage system, such as a random access memory (RAM) for temporary storage of information, and/or a read only memory (ROM) for permanent storage of information. In some embodiments, the storage system 111 may also be an external storage system, such as an external hard disk, a storage card, or a data storage medium.

In one embodiment, the disk combination system 10 includes an initialization module 101, a USB port detection module 102, and a disk combining module 103. The modules 101-103 may comprise computerized instructions in the form of one or more programs that are stored in the storage system 111 and executed by the at least one microprocessor 112. Detailed descriptions of each module will be given in the following paragraphs.

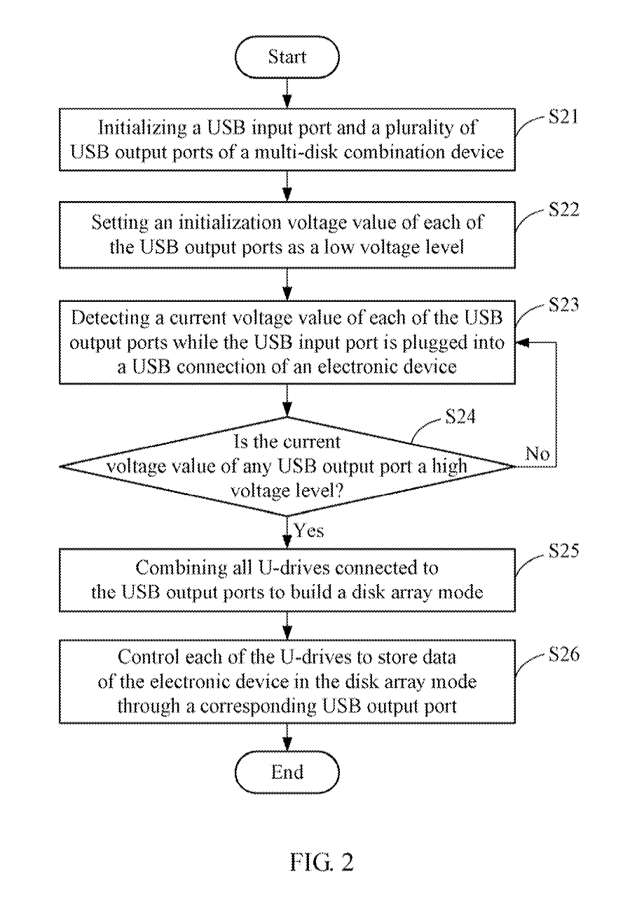

FIG. 2 is a flowchart of one embodiment of a method for combining a plurality of U-drives using the multi-disk combination device 1 of FIG. 1. Depending on the embodiment, additional steps may be added, others removed, and the ordering of the steps may be changed.

In step S21, the initialization module 101 initializes the USB input port 12 and each of the USB output ports 13 of the multi-disk combination device 1. In the embodiment, the multi-disk combination device 1 connects to the electronic device 2 through the USB input port 12, and connects to one or more U-drives 3 through the USB output ports 13.

In step S22, the initialization module 101 sets an initialization voltage value of each of the USB output ports 13 as a low voltage level. In one embodiment, the low voltage level is represented by a logic number “0” and the initialization voltage value of each of the USB output ports 13 may be set as zero volts.

In step S23, the USB port detection module 102 detects a current voltage value of each of the USB output ports 13 while the USB input port 12 is plugged into a USB connection of the electronic device 2. In the embodiment, the USB port detection module 102 detects whether the current voltage value of each of the USB output ports 13 is zero volts or more than zero volts when the USB input port 12 is plugged into the USB connection of the electronic device 2.

In step S24, the USB port detection module 102 determines whether the current voltage value of any USB output port 13 is a high voltage level, to determine whether the USB output port 13 is connected to a U-drive 3. In one embodiment, the high voltage level is represented by a logic number “1” and the current voltage value of each of the USB output ports 13 may be 5 volts. If the current voltage value of one of the USB output ports 13 is a high voltage level, the USB port detection module 102 determines that the USB output port 13 is connected to a U-drive 3, and step S25 is implemented. Otherwise, if the current voltage value of the USB output port 13 is a low voltage level, the USB port detection module 102 determines that no U-drive 3 is connected to the USB output port 13, and the process remains in step S23.

In step S25, the disk combining module 103 combines all U-drives 3 which are determined as being connected to the USB output ports 13 to build a disk array mode for the U-drives 3. In the embodiment, the disk array mode is defined as a redundant array of independent disks (RAID) mode that includes at least two U-drives 3.

In step S26, the disk combining module 103 controls each of the U-drives 3 to store data of the electronic device 2 in the disk array mode through a USB output port 13 corresponding to the U-drive 3. In the disk array mode, each of the U-drives provides more storage capacity to store massive data from the electronic device 2.

All of the processes described above may be embodied in, and fully automated via, functional code modules executed by one or more general purpose processors of computing devices. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

Although certain disclosed embodiments of the present disclosure have been specifically described, the present disclosure is not to be construed as being limited thereto.

Various changes or modifications may be made to the present disclosure without departing from the scope and spirit of the present disclosure.

What is claimed is:

1. A multi-disk combination device, comprising:
a universal serial bus (USB) input port that electronically connects to a USB connection of an electronic device;
a plurality of USB output ports, each of the USB output ports electronically connecting to a USB flash drive;
a control chipset comprising a storage system and at least one microprocessor; and
one or more programs stored in the storage system and executed by the at least one microprocessor, the one or more programs comprising:
an initialization module that initializes the USB input port and each of the USB output ports, and sets an initialization voltage value of each of the USB output ports as a low voltage level;
a USB port detection module that detects a current voltage value of each of the USB output ports while the USB input port is plugged into the USB connection of the electronic device, and determines whether any USB output port connects to a USB flash drive by checking whether the current voltage value of the USB output port is a high voltage level; and
a disk combining module that builds a disk array mode for all USB flash drives connected to the USB output ports, and controls each of the USB flash drives to store data of the electronic device in the disk array mode through a USB output port corresponding to the USB flash drive.

2. The multi-disk combination device according to claim 1, wherein each of the USB output ports and the corresponding USB flash drive form a data transmission channel between the electronic device and the corresponding USB flash drive.

3. The multi-disk combination device according to claim 1, wherein the USB port detection module determines that no USB flash drive is connected to the USB output port if the current voltage value of the USB output ports is a low voltage level.

4. The multi-disk combination device according to claim 3, wherein the USB port detection module further determines that the USB output port is connected with a USB flash drive if the current voltage value of the USB output port is a high voltage level.

5. The multi-disk combination device according to claim 4, wherein the low voltage level is represented by a logic number “0”, and the high voltage level is represented by a logic number “1”.

6. The multi-disk combination device according to claim 1, wherein the disk array mode is a redundant array of independent disks (RAID) mode that includes at least two USB flash drives.

7. A method for combining a plurality of universal serial bus (USB) flash drives using a multi-disk combination device, the method comprising:
initializing a USB input port and a plurality of USB output ports of the multi-disk combination device;
setting an initialization voltage value of each of the USB output ports as a low voltage level;
detecting a current voltage value of each of the USB output ports while the USB input port is plugged into an USB connection of an electronic device;
determining whether any USB output port connects to a USB flash drive by checking whether the current voltage value of the USB output port is a high voltage level;
building a disk array mode for all USB flash drives connected to the USB output ports; and
controlling each of the USB flash drives to store data of the electronic device in the disk array mode through a USB output port corresponding to the USB flash drive.

8. The method according to claim 7, wherein each of the USB output ports and the corresponding USB flash drive form a data transmission channel between the electronic device and the corresponding USB flash drive.

9. The method according to claim 7, wherein the determining step comprises:
determining that no USB flash drive is connected to the USB output port if the current voltage value of the USB output ports is a low voltage level.

10. The method according to claim 9, wherein the determining step further comprises:
determining that the USB output port is connected with a USB flash drive if the current voltage value of the USB output port is a high voltage level.

11. The method according to claim 10, wherein the low voltage level is represented by a logic number “0”, and the high voltage level is represented by a logic number “1”.

12. The method according to claim 7, wherein the disk array mode is defined as a redundant array of independent disks (RAID) mode that includes at least two USB flash drives.

13. A non-transitory storage medium having stored thereon instructions that, when executed by at least one microprocessor of a multi-disk combination device, causes the multi-disk combination device to perform a method for combining a plurality of universal serial bus (USB) flash drives, the method comprising:
initializing a USB input port and a plurality of USB output ports of the multi-disk combination device;
setting an initialization voltage value of each of the USB output ports as a low voltage level;
detecting a current voltage value of each of the USB output ports while the USB input port is plugged into an USB connection of an electronic device;
determining whether any USB output port connects to a USB flash drive by checking whether the current voltage value of the USB output port is a high voltage level;
building a disk array mode for all USB flash drives connected to the USB output ports; and
controlling each of the USB flash drives to store data of the electronic device in the disk array mode through a USB output port corresponding to the USB flash drive.

14. The storage medium according to claim 13, wherein each of the USB output ports and the corresponding USB flash drive form a data transmission channel between the electronic device and the corresponding USB flash drive.

15. The storage medium according to claim 13, wherein the determining step comprises:
determining that no USB flash drive is connected to the USB output port if the current voltage value of the USB output ports is a low voltage level.

16. The storage medium according to claim 15, wherein the determining step further comprises:
determining that the USB output port is connected with a USB flash drive if the current voltage value of the USB output port is a high voltage level.

17. The storage medium according to claim 16, wherein the low voltage level is represented by a logic number “0”, and the high voltage level is represented by a logic number “1”.

18. The storage medium according to claim 13, wherein the disk array mode is defined as a redundant array of independent disks (RAID) mode that includes at least two USB flash drives.
